(19) United States
(12) Patent Application Publication
(10) Pub. No.: US 2007/0059676 A1
(43) Pub. Date: Mar. 15, 2007

(54) Interactive animation for entertainment and instruction using networked devices

(76) Inventor: Jinnyeo Jeong, Menlo Park, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/269,197

(22) Filed: Oct. 26, 2005

Related U.S. Application Data
(60) Provisional application No. 60/716,606, filed on Sep. 12, 2005.

(51) Int. Cl. G09B 11/00; G09B 25/00

(52) U.S. Cl. 434/365; 434/81

(57) ABSTRACT

A computer-implemented facility or system is adapted to provide interactive animation for downloading or streaming to MP3 enabled devices with display capabilities.

### CROSS-REFERENCE TO RELATED APPLICATIONS

This application claims priority to U.S. Provisional Application No. 60/716,606, filed on Sep. 12, 2005, which is hereby incorporated by reference in its entirety.

### BACKGROUND

MP3 is a popular digital audio codec, so popular that most people believe it to be synonymous with digital music without really knowing what it stands for. The name MP3 is derived from MPEG-1 Audio Layer 3. MP3 is designed to greatly reduce the amount of data required to represent audio, and yet retain enough audio quality to satisfy most listeners.

More importantly, MP3 revolutionized consumer behavior towards playing music. Today, the downloading of MP3 music is widespread. Music is no longer tied to physical objects like CDs. Instead, digital music can be transmitted across a network, wireless or otherwise, to be played on MP3 enabled players of the consumer's choice.

To underscore the importance of MP3 music in the market place, wireless operators, ISPs, and content providers such as Verizon, Orange, Apple Computer and DoCoMo recognize the need to provide mobile phones equipped with MP3 players. However, mobile consumer electronics that are MP3 enabled provide limited display when the MP3 music is played. For example, the display on the mobile device is usually restricted to a display of the song titles, names of artists and limited additional information on the song.

### BRIEF DESCRIPTION OF THE DRAWINGS

FIG. 1 is a high-level network diagram showing aspects of a computerized environment in which the facility operates, according to certain embodiments.

FIG. 2 is a block diagram showing some of the components typically incorporated in at least some of the computer systems and other devices on which the facility executes.

FIGS. 3A and 3B are flowcharts that illustrate high-level aspects of providing entertainment and a teaching tool related to digital music applications.

### DETAILED DESCRIPTION

According to certain embodiments, a computer-implemented facility or system is adapted to provide interactive animation for downloading or streaming to MP3 enabled devices with display capabilities. Such user devices include but are not limited to mobile phones, PDAs, MP3 players, PCs, etc. The embodiments are not restricted to the use of MP3 music. Any suitable audio codec may be used to provide digital music for downloading or streaming digital music to networked devices. Non-limiting examples of audio codecs include AC3 Filter, AC-3 Decompressor, CoreVorbis Decoder, Vorbis Ogg ACM Codec, LAME MP3 Encoder, Monkey's Audio, LAME ACM MP3 Codec, RealAudio, and QDesign Music Codec. Further, the embodiments are not restricted to the use of any particular video codec for displaying video on the user device. Non-limiting examples of vidio codecs include RealVideo, H261, H263, MPEG-4, ClearVideo, VDOLive, Lite VDO, FFDShow MPEG-4, DivX 6.0, Koepi's XviD Codec, DivX Free, Stinky's MPEG-2, OggDS/OGM Codec, Ligos Indeo Codec.

The embodiments are not limited to any particular types of network technologies. The embodiments may employ various network technologies including wired, wireless, guided or line-of-sight optical, and radio frequency networking.

According to one aspect of certain embodiments, the interactive animation includes one or more 2D graphics characters and/or 3D graphics characters. According to another aspect, the animated graphics character is adapted to perform dance moves for display to the user on the display screen of the digital audio codec enabled device when the user begins playing digital music on the device. According to certain embodiments, the device may also be video codec enabled.

According to another aspect, there are one or more stored pre-determined choreography files mapped to each digital song title. Thus, various choreography files and animated characters can be downloaded to the digital audio codec enabled device. According to another aspect, the choreography for a given song is dynamically generated by analyzing the music as the music is being played on the device. According to another aspect, the user can choreograph the movement of the animated character using controls provided on the digital audio codec and visual display enabled device.

According to yet another aspect, the animated character is adapted to remember the dance moves choreographed by the user. In other words, the user can teach the animated character dance moves and then save the choreography. Additionally, the user can send the saved choreography with or without the animated character to another user's digital audio codec enabled device. The recipient user either can use the choreography file along with the transmitted animated character or with other downloaded animated characters. The recipient user can download the same music as that of the sender user such that when the recipient user plays the downloaded music, the animated character dances according to the choreographed dance moves created by the sender user. According to certain embodiments the recipient can play any suitable music to which the animated character received from the sender user can dance.

According to certain embodiments, the facility or system also provides special effects for downloading, streaming or otherwise transmitting to the user's device. Some non-limiting examples of special effects include lighting, background display, simulated camera motion, and zooming in & out.

According to certain embodiments, the animated characters, special effects files, and choreography files can be downloaded, streamed or otherwise transmitted to the desired digital audio and video enabled device that is equipped with a display screen. Further, the animation, choreography and special effects files on the digital audio and video enabled device can be synchronized with corresponding files on the user's PC or on other devices.

According to certain embodiments, the user may pay for a subscription service in order to use the facility. Alternatively, the user may pay for each downloaded, streamed or otherwise transmitted file. According to certain embodiments, the user can buy the service using credits earned by the user. For example, the user can earn credits by offering to other users animated characters and/or choreography files, and/or special files that are created by the user.

A computer-implemented facility (hereafter “the facility”) for creating, storing and transmitting, animated characters, digital music, choreography and special effects files to networked devices is described.

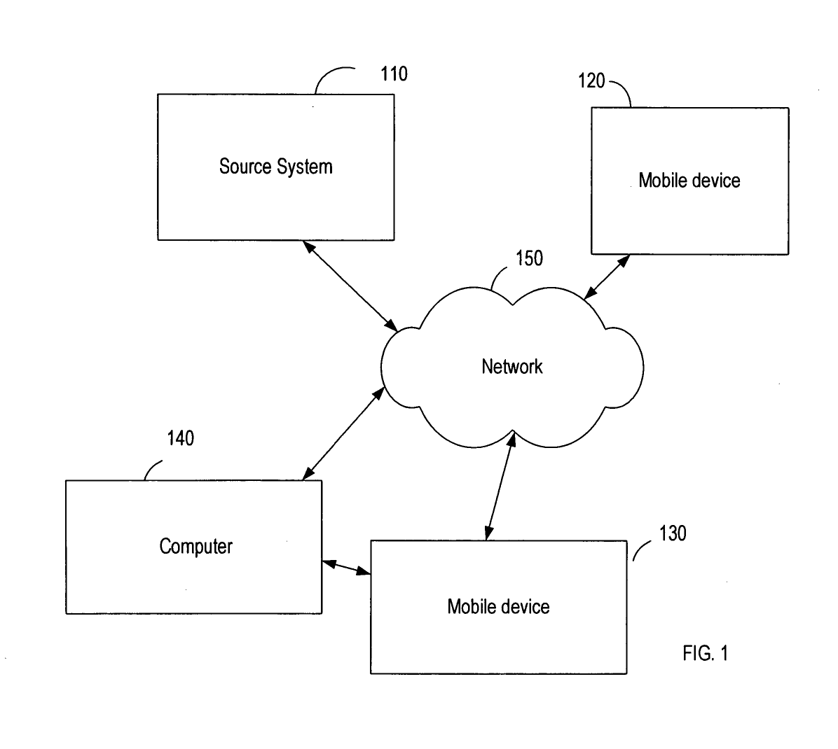

FIG. 1 is a high-level network diagram showing aspects of a hardware environment in which the facility operates. FIG. 1 shows a source system 110, mobile devices 120, 130, a computer 140 and a network 150. Even though only 2 mobile devices, one computer, one network and one source system are shown in FIG. 1, the hardware environment may include a plurality of mobile devices, computers, networks, and source systems.

Animated characters, digital music and choreography and special effects files can be downloaded, streamed or otherwise transmitted from Source system 110 to mobile devices 120, 130 and to computer 140. Mobile devices 120, 130 and computer 140 can exchange and/or synchronize digital music, animated characters, choreography and special effects files.

The computer systems shown in FIG. 1 are connected via network 150, which may use a variety of different networking technologies, including wired, guided or line-of-sight optical, and radio frequency networking. In some embodiments, the network includes the public switched telephone network. Network connections established via the network may be fully-persistent, session-based, or intermittent, such as packet-based. While the facility typically operates in an environment such as is shown in FIG. 1 and described above, those skilled in the art will appreciate the facility may also operate in a wide variety of other environments.

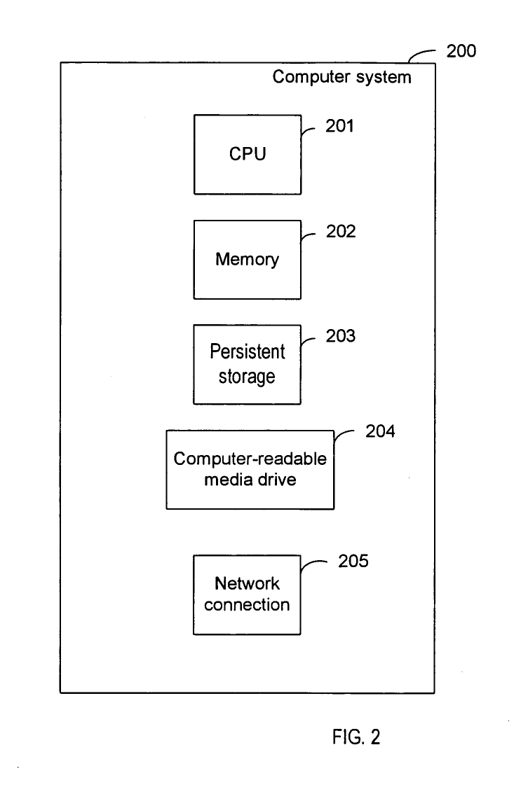

FIG. 2 is a block diagram showing some of the components typically incorporated in at least some of the computer systems and other devices on which the facility executes, including some or all of the server and client computer systems shown in FIG. 1. These computer systems and devices 200 may include one or more central processing units (“CPUs”) 201 for executing computer programs; a computer memory 202 for storing programs and data—including data structures—while they are being used; a persistent storage device 203, such as a hard drive, for persistently storing programs and data; a computer-readable media drive 204, such as a CD-ROM drive, for reading programs and data stored on a computer-readable medium; and a network connection 205 for connecting the computer system to other computer systems, such as via the Internet, to exchange programs and/or data—including data structures. While computer systems configured as described above are typically used to support the operation of the facility, those skilled in the art will appreciate that the facility may be implemented using devices of various types and configurations, and having various components.

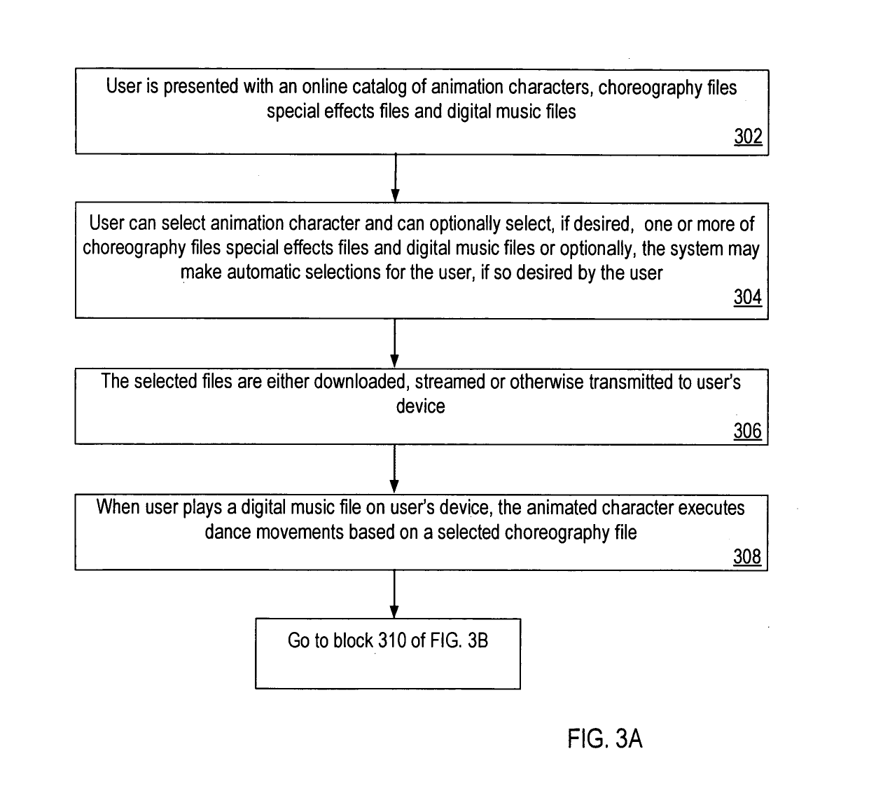

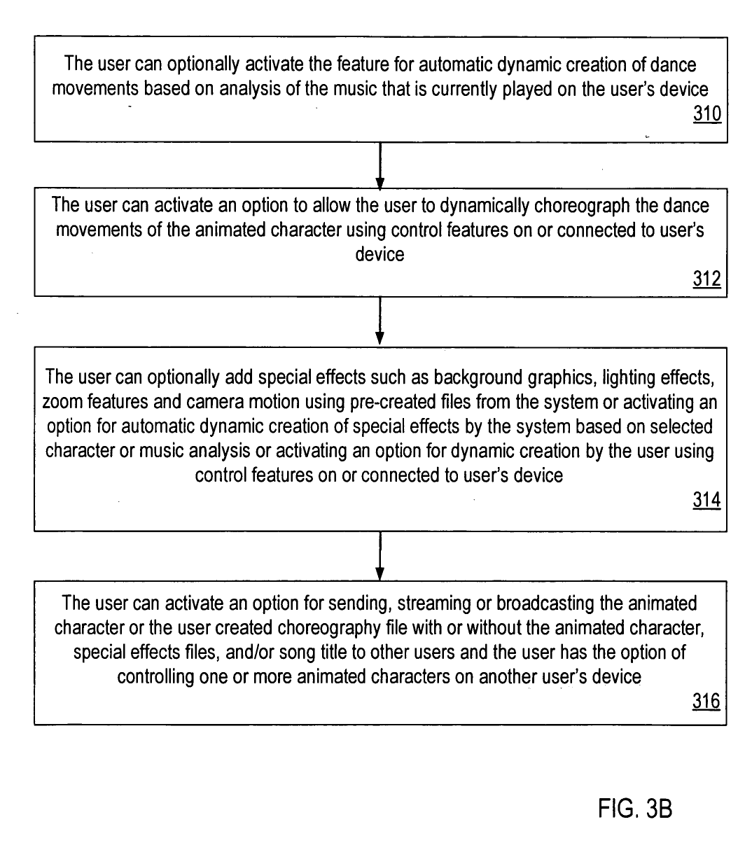

FIGS. 3A and 3B are flowcharts that illustrate high-level aspects of providing entertainment and a teaching tool related to digital music applications. At block 302, the system displays, to the user through user's device, an online catalog of animation characters, choreography files, special effects files and digital music files along with price information and description.

At block 304, the user selects one or more animation characters and optionally selects one or more of choreography files, special effects files and digital music files. The user may choose not to select a digital music file for downloading if the user decides to play the digital music files previously stored on the user's device. According to certain embodiments, the system may automatically select or suggest for selection choreography files and/or special effects files based on information on the user's music files. For example, if the user had previously purchased a song, the system can select the choreography and special effects that are suitable for that song.

At block 306, the system downloads, streams or otherwise transmits the user selected files to the user's device. At block 308, when the user plays a desired digital music file on user's device, the downloaded, streamed or otherwise transmitted animated character begins to execute dance moves based on a selected choreography file.

Alternatively, at block 310, the user can optionally activate a feature for the automatic dynamic creation of dance movements based on analysis of the music that is currently being played on the user's device. The choice of dance movements can be based on the animated character selected by the user. For example, if the selected character is a ballerina, then the dance moves may be in the ballet style. As another option, the automatic dynamic creation of dance movements is based on the rhythm of the music that is being concurrently played on the user device or based on the classification of the music that is being concurrently played. Classification of music refers to whether the music is classified as classical, rap, techno, rock & roll, country, folk, etc.

As yet another alternative, at block 312, the user can activate an option to allow the user to dynamically choreograph the dance moves of the animated character using control features on user's device, such as an input keypad, joystick, motion sensors, and video sensors on or connected to the user's device.

At block 314, the user can optionally add special effects such as static and animated background graphics such as background video, lighting effects, zoom features and simulated camera motion using the corresponding downloaded, streamed or otherwise transmitted files from the system. Static background graphics includes static images of scenery of a beach, mountains, city views, etc. The user also has the option of creating or adding text information.

Alternatively, the user can optionally activate an option for the automatic dynamic creation of special effects based on the selected character and/or the choreography and/or the analysis of the music that is currently being played on the users device. According to certain embodiments, the user can activate an option to allow the user to dynamically create special effects using control features on user's device, such as an input keypad, joystick, motion sensors, and video sensors on or connected to the on user's device.

At block 316, the user can activate an option to send, stream or broadcast or upload to a server for storage and forwarding the animated character or the user created choreography with or without the animated character, the special effects, music and/or song title to other users. According to certain embodiments, a user has the option of controlling one or more animated characters on another user's device. For example, assume that user A controls device M and user B controls device BB. Further assume that user A has Character AAA on device AA, and that user B has Character BBB on device BB. User A and user B can each send their respective characters to each other. Thus, user A can view Character AAA and Character BBB on device AA. Similarly, user B can view Character AAA and Character BBB on device BB. User A can control the movements of Character AAA on device AA and device BB, simultaneously. Similarly, user B can control the movements of Character BBB on device BB and device AA, simultaneously. Thus, Character AAA and Character BBB can be made to dance together, and/or kiss and/or embrace, for example. By using such an option, users can entertain themselves and entertain other users and/or instruct each other on dance moves through animated characters.

According to certain embodiments, the user has the option of customizing an animated character by modifying the appearance of the character such as modifying make-up, coloration or facial expressions. The user may also have the option of choosing accessories such as clothing, shoes, hairstyle, etc for the character.

According to certain embodiments, the animated characters are characters in a computer-implemented game that is playing on the user's device. The actions and movements of the game characters can be affected by the music that is concurrently played on the user's device. For example, the game characters can move based on the rhythm or classification of the music that is concurrently being played. As another option, the mode of play of the game by the user can affect the automatic selection of music that is to be played on the device, such as during a random play of music on the device.

According to certain embodiments, the user has the option of creating new animated characters by using existing 2D images such as photographs or pictures and/or 3D images and video clips.

One or more options and features as described herein may be pre-programmed in the user's device for the convenience of the user so that the user is not required to make manual selections. However, the user may override the pre-programmed options and features through manual selection if the user so desires.

In the foregoing specification, embodiments of the invention have been described with reference to numerous specific details that may vary from implementation to implementation. It will be evident that various modifications and changes may be made thereto without departing from the broader spirit and scope of the invention. The specification and drawings are, accordingly, to be regarded in an illustrative rather than a restrictive sense.

We claim:

1. A computer-implemented method for entertainment and instruction, the computer-implemented method comprising:
allowing a user to select at least one interactive animated character operable on a user device of said user; and
transmitting said at least one interactive animated character to said user device, wherein said user device is adapted for playing digital music and displaying said at least one interactive animated character, and wherein said at least one interactive animated character is at least adapted to move based on input by said user using said user device.

2. The computer-implemented method of claim 1, further comprising allowing said user to select an option for automatic selection, based on information on music files on said user device, of one or more of: said at least one interactive animated character, pre-created choreography files, and special effects files.

3. The computer-implemented method of claim 1, further comprising allowing said user to manually select one or more of: said at least one interactive animated character, pre-created choreography files, special effects files, and music files for transmission to said user device.

4. The computer-implemented method of claim 1, further comprising allowing for automatic dynamic creation of choreography for said interactive animated character when said at least one interactive animated character is being displayed on said user device and based on music that is being played simultaneously on said user device.

5. The computer-implemented method of claim 4, wherein said automatic dynamic creation of choreography based on said music further comprises using rhythm information of said music in said automatic dynamic creation of choreography.

6. The computer-implemented method of claim 4, wherein said automatic dynamic creation of choreography based on said music further comprises using classification information of said music in said automatic dynamic creation of choreography.

7. The computer-implemented method of claim 1, further comprising allowing for automatic dynamic creation of special effects during display and interactive animation of said at least one interactive animated character on said user device.

8. The computer-implemented method of claim 7, wherein said special effects comprises zooming in and out, simulated camera motion, lighting effects, static background graphics, animated background graphics, and video background display.

9. The computer-implemented method of claim 1, further comprising allowing said user to teach said at least one interactive animated character dance moves through control input that is associated with said user device and wherein said at least one interactive animated character is adapted to remember said dance moves.

10. The computer-implemented method of claim 1, further comprising allowing said user to customize said at least one interactive animated character by allowing said user to modify any one of: movements and an appearance of said at least one interactive animated character.

11. The computer-implemented method of claim 9, further comprising allowing said user to upload to a shared server said at least one interactive animated character for sharing with a plurality of users after teaching said at least one interactive animated character to dance, wherein said plurality of users can view or learn said dance moves by observing said at least one interactive animated character received from said user.

12. The computer-implemented method of claim 9, wherein said control input is through input mechanisms that are on said user device or operably connected to said user device wherein said mechanisms comprise: a joy stick, a motion sensor, a keypad, and a video sensor.

13. The computer-implemented method of claim 1, further comprising allowing said user to synchronize said at least one interactive animated character, choreography files, and special effects files with corresponding files on other devices.

14. The computer-implemented method of claim 1, further comprising allowing for automatic dynamic creation of special effects based on music that is being played simultaneously on said user device.

15. The computer-implemented method of claim 1, further comprising allowing said user to transmit said at least one interactive animated character to a second user's user device and allowing said user to continue to control said at least one interactive animated character on said second user's user device and wherein said second user causes a second interactive animated character to interact with said at least one interactive animated character on said second user's user device.

16. The computer-implemented method of claim 1, further comprising allowing said user to transmit to a second user's user device one or more of: choreography files, special effects files, music files and one or more interactive animated characters.

17. The computer-implemented method of claim 1, wherein said transmitting includes streaming.

18. The computer-implemented method of claim 1, wherein said transmitting includes downloading.

19. The computer-implemented method of claim 1, wherein said user device comprises: a mobile phone, a PDA, a computer, a portable device, a gaming device, a karaoke device.

20. The computer-implemented method of claim 1, further comprising allowing said user to select accessories for said at least one interactive animated character, wherein said accessories include clothing, shoes, and jewelry.

21. The computer-implemented method of claim 10, wherein allowing said user to modify appearance of said at least one interactive animated character includes modifying facial expressions, hairstyle, and coloration of said at least one interactive animated character.

22. The computer-implemented method of claim 1, further comprising displaying text information on said user device.

23. The computer-implemented method of claim 1, further comprising affecting movement of characters in a computer-implemented game playing on said user device based on music that is concurrently played on said user device.

24. The computer-implemented method of claim 23, further comprising affecting a mode of play of said computer-implemented game based on said music that is concurrently played on said user device.

25. The computer-implemented method of claim 1, further comprising affecting music that is being played on said user device based on a mode of play of a computer-implemented game that is concurrently being played on said user device.

26. The computer-implemented method of claim 1, further comprising affecting music that is being played on said user device based on historical information on movement of characters as manipulated by said user of a computer-implemented game that is concurrently being played on said user device.

27. The computer-implemented method of claim 1, further comprising allowing said user to create a new interactive animated character using one or more of existing 2D images, 3D images, and video clips.

28. The computer-implemented method of claim 23, further comprising automatic dynamic creation of background graphics, lighting effects, based on said music that is concurrently played on said user device.

29. The computer-implemented method of claim 2, further comprising charging said user a fee for said at least one interactive animated character, said pre-created choreography files, and said special effects files.

30. The computer-implemented method of claim 2, further comprising allowing said user to offer interactive animated characters, choreography files, and special effects files that are created by said user to other users in exchange for credits.

31. One or more propagated data signals collectively conveying data that causes a computing system to perform a method for entertainment and instruction, the method comprising:
providing at least one interactive animated character for sending to a user device, wherein said user device is adapted for playing digital music and displaying said at least one interactive animated character, and wherein said at least one interactive animated character is adapted to move based on either pre-created or dynamically generated choreography files or said at least one interactive animated character can be dynamically caused to move based on input by a user through said user device when playing said digital music on said user device.

32. The one or more propagated data signals of claim 31, further causing allowing said user to select an option for automatic selection of, based on information on music files on said user device, one or more of: said at least one interactive animated character, pre-created choreography files, and special effects files.

33. The one or more propagated data signals of claim 31, further causing allowing said user to transmit said at least one interactive animated character to a second user's user device and allowing said user to continue to control said at least one interactive animated character on said second user's user device and wherein said second user causes a second interactive animated character to interact with said at least one interactive animated character on said second user's user device.

34. A system for entertainment and instruction, the system comprising:
a receiving means for receiving at least one interactive animated character on a user device;
a control means for controlling movements of said at least one interactive animated character on said user device;
a display means for displaying said at least one interactive animated character on said user device; and
a music playing means for playing music on said user device.

35. The system of claim 34, further comprising a selection means for automatic selection of, based on information on music files on said user device, one or more of: said at least one interactive animated character, pre-created choreography files, and special effects files.

36. The system of claim 34, further comprising a transmission means for transmitting said at least one interactive animated character to a second user's user device and wherein said user continues to control said at least one interactive animated character on said second users user device using said control means and wherein said second user causes a second interactive animated character to interact with said at least one interactive animated character on said second user's user device.
